(19) United States
(12) Patent Application Publication
(10) Pub. No.: US 2011/0168862 A1
(43) Pub. Date: Jul. 14, 2011

(54) Fish Tank Rescue Brace

(76) Inventor: Bryan Gilbert DeRocher, Wake Forest, NC (US)

(21) Appl. No.: 12/784,462

(22) Filed: Jul. 27, 2010

(51) Int. Cl. F16M 13/00

(52) U.S. Cl. 248/351

(57) ABSTRACT

A linear brace used to prevent the bowing and complete failure of a glass aquarium when the manufacturer's plastic, center brace fails. Through general steel fabrication techniques, the tubular, mild steel is cut to a specified length determined by the aquarium width. Both ends of the tubular steel are cut in 45 degree angles and smaller pieces of the tubular steel which protrude in a downward direction. A three eight's nut is welded to the bottom of the backside of the brace. A three eights bolt is threaded in the nut that was previous welded to the tube. After the bolt is threaded into the nut an additional nut is threaded onto the opposite end of the bolt and plug welded. This creates a adjustable mechanism to allow for easy installation. Then When the brace is in place on the aquarium, both downward tubes reside on the outside of the aquarium and are secured by adjusting the thread and nut mechanism.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISC APPENDIX

Not Applicable

### BACKGROUND OF THE INVENTION

This invention relates to a “brace”. The definition of a brace is “to make something stronger, to reinforce”. The Fish Rescue Brace is used to reinforce or make stronger a compromised center support on a glass aquarium thereby avoiding total aquarium failure.

In order to hold a glass aquarium together, the manufacturer incorporates a plastic flange around the top of the glass aquarium. This flange includes a plastic support that runs across the width of the aquarium at the center point of the aquarium. This center brace provides the structural integrity of the aquarium by applying the correct amount of pressure on both sides of the glass to prevent the glass from bowing.

After time, the structural integrity of the center brace may be compromised and may lead to the cracking and eventually breakage of the center brace.

Common reasons for a compromised center brace include:
Light fatigue due to the intense lighting that is commonly used in the aquarium.
Deterioration of the plastic center brace due to age.
Mishandling of the aquarium or accidental damage such as dropping something on the center brace.

Once the structural integrity of the center brace is compromised, the aquarium glass will bow due to the pressure of the water against the glass. If this is not repaired it will lead to total aquarium failure resulting a broken tank, flooded floor and dead livestock.

The aquarium manufacture's method for repairing the broken center brace is to replace the entire top flange. This involves removing all water and livestock from the tank and carefully removing the top flange with a razor blade, screw driver or other similar device.

Removing and replacing the flange requires a lot of skill and luck to successfully remove it without further damaging the structural integrity of the aquarium.

This type of repair is not something most homeowners have the skill set, time or ability to do; as a result many will simply tear the aquarium down and not replace it therefore giving up the hobby.

The purpose of this invention is to provide a permanent replacement for the center brace thereby providing structural integrity without relying on the manufacturer's plastic center brace.

### BRIEF SUMMARY OF THE INVENTION

The Fish Tank Rescue Brace provides support for a glass aquarium where the structural integrity of the center brace has been compromised or has failed. This is accomplished by the use of a specialized, adjustable brace that is placed on the aquarium to sever as a permanent center brace. With this brace in place, the structural integrity of the aquarium is once again achieved.

Unlike replacing the flange which requires all water and inhabitants/livestock be removed, installation of the Fish Tank Rescue Brace requires that the water level in the aquarium be reduced by only 25%, leaving 75% of the water in the aquarium thereby saving the aquarium inhabitants/livestock. The reduction in water volume is enough to relieve enough of the pressure on the aquarium walls to allow the brace to be easily installed and secured.

The manufacturer's flange does not have to be removed as the Fish Tank Rescue Brace works in conjunction with the flange to provide the same functionality as the compromised center brace.

The Fish Tank Rescue Brace will not age, is not affected by light fatigue and will not break.

The Fish Tank Rescue Brace is a device that can be quickly and easily installed on an existing aquarium thereby saving the contents of the aquarium and preventing water damage to the home.

### BRIEF DESCRIPTION OF THE SEVERAL VIEWS OF THE DRAWING

FIG. 1 is the right side view of the brace.

FIG. 2 is the front view of the brace looking at it as it will sit on the glass aquarium.

FIG. 3 is the top view of the brace looking down into the glass aquarium.

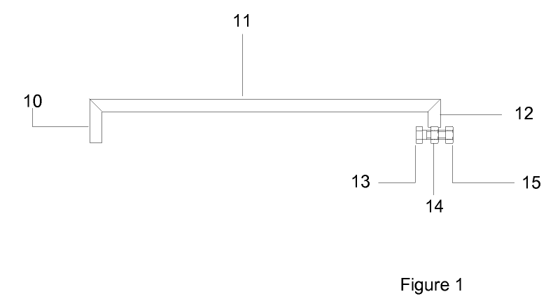

### DETAILED DESCRIPTION OF THE INVENTION

Through general steel fabrication techniques, the tubular, mild steel is cut to a specified length determined by the aquarium width. Both ends of the tubular steel are cut in 45 degree angles and attached to smaller pieces of tubular steel which protrude in a downward direction. Then adjustable mechanism is fabricated and attached to the bottom of the backside to allow for easy installation.

I claim that the Fish Rescue Brace:

I. Provides a support mechanism to prevent complete glass aquarium failure in the event the manufacturer's center brace fails or is compromised.

II. Provides a permanent solution for a broken manufacturer's center brace.

III. When proactively installed, will prevent center brace failure.
